(19) United States
(12) Patent Application Publication
(10) Pub. No.: US 2026/0017047 A1
(43) Pub. Date: Jan. 15, 2026

(54) UPDATING SOFTWARE USING HYBRID PARTITIONING

(71) Applicant: RED HAT, INC., Raleigh, NC (US)

(72) Inventor: Eric Curtin, Dublin (IE)

(21) Appl. No.: 18/768,548

(22) Filed: Jul. 10, 2024

(51) Int. Cl. G06F 8/656; G06F 9/4401; G06F 11/14

(52) U.S. Cl. CPC G06F 8/656; G06F 9/4408; G06F 11/1433

(57) ABSTRACT

A computing device can implement hybrid partitioning to apply a software update. The computing device can receive an update file to generate an updated version of software of the computing device. The update file can correspond to an update request generated while running an active system configuration of the computing device. The computing device can generate an updated system configuration by applying the update file to an inactive system configuration of the computing device associated with a first partition while the active system configuration corresponding to a second partition remains operational. Additionally, the computing device can generate an updated directory in a system partition of the computing device based on the update file. The updated directory can correspond to the updated system configuration. The computing device can modify a partition table associated with the first and second partitions such that the computing device boots using the updated system configuration.

### TECHNICAL FIELD

The present disclosure relates generally to software updates. More specifically, but not by way of limitation, this disclosure relates to updating software using hybrid partitioning.

### BACKGROUND

After releasing a software application, software developers can provide software updates for the software application. A software update is program code that is downloadable by end users to their computing devices for patching or replacing an existing (e.g., older) version of the software application on the computing devices. Generally, a software update may resolve bugs, improve security, introduce new functionality, or remove existing functionality. Once the software update is ready for release, the software developers may push the software update to a software repository or otherwise make the software update available to the end users. The end users may then download the software update to their computing devices and install the software update thereon.

### BRIEF DESCRIPTION OF THE DRAWINGS

FIG. 1 is a block diagram of an example of a computing environment for using hybrid partitioning to apply a software update according to some examples of the present disclosure.

FIG. 2 is a block diagram of an example of a portion of a computing device to apply a software updating using hybrid partitioning according to some examples of the present disclosure.

FIG. 3 is a block diagram of an example of a computing device for using hybrid partitioning to apply a software update according to some examples of the present disclosure.

FIG. 4 is a flowchart of a process for using hybrid partitioning to apply a software update according to some examples of the present disclosure.

### DETAILED DESCRIPTION

Software developers can provide software updates for a software application to end users. In many industries, software updates have become a critical aspect of maintenance, safety assurance, and functionality enhancement. In some cases, a computing device may leverage a single partition to apply a software update. But the single partition can result in a single point of failure, increasing risks to system integrity. Additionally, if the single partition is prior to a root filesystem of the computing device, the single partition may lack a filesystem to logically separate current data and updated data associated with the software update. In other cases, the computing device can use a dual partition deployment to apply the software update by distinguishing between a current system configuration and an updated system configuration. But the dual partition deployment can result in inefficient storage management. Specifically, one partition of the computing device may be unable to use storage allocated to another partition of the computing device, which may result in significant amounts of unused storage. Additionally, it can be difficult to deduplicate data on separate partitions, further causing inefficiencies in storage usage.

Some examples of the present disclosure can overcome one or more of the issues mentioned above by using hybrid partitioning to apply a software update. The hybrid partitioning of the computing device can involve using separate partitions for a boot sequence of the computing device such that the computing device can include at least two system configurations that can be updated separately. Additionally, the hybrid partitioning can involve employing a system partition that includes organizational structures to distinguish between the current system configuration and the updated system configuration. The hybrid partitioning can ensure that an update stack starts at the lowest level, such as firmware or a bootloader. Additionally, by employing both separate partitions and the system partition, the hybrid partitioning can provide redundancy and fault tolerance as well as storage efficiency and organizational simplicity. The separate partitions and the organizational structures of the system partition can enable switching from the current system configuration to the updated system configuration on reboot of the computing device. The computing device can implement a staged update process such that the software update is applied to an inactive partition while the current system configuration associated with an active partition remains operational.

In one particular example, the computing device can initiate a software update to implement an updated version of its operating system based on an update file downloaded from an update repository. The computing device may initiate the software update in response to user input provided by a user of the computing device. Once the computing device receives the update file from the update repository, the computing device can compare the update file with a current version of the operating system to determine one or more differences. The computing device can include at least two partitions of its disk such that a first boot partition can run a current version of the operating system while a second boot partition is updated to implement the updated version of the operating system. Additionally, the computing device can include a system partition that has at least two directories with a respective directory corresponding to each boot partition.

Based on the differences between the update file and the current version of the operating system, the computing device can update the second boot partition and a corresponding directory of the system partition. For example, the computing device can flash the second boot partition to update the second boot partition with certain bytes of data based on the update file. Additionally, by comparing the update file and the current version of the operating system, the computing device can determine that a portion of the current version of the operating system is unchanged for the updated version of the operating system. Accordingly, the computing device can avoid unnecessary storage consumption by mapping the unchanged portion of the current version of the operating system to the corresponding directory of the second boot partition. In other words, a first directory that corresponds to the first boot partition can share the unchanged portion of the operating system with a second directory corresponding to the second boot partition. Additionally, the computing device can copy a remaining portion of the update file to the second directory to update the second directory. Updating the second boot partition and its corresponding directory can occur while the current version of the operating system remains operational via the first boot partition and its corresponding directory.

Once the second boot partition and the second directory are updated based on the update file, the computing device can reboot using the second boot partition and the second directory to run the updated version of the operating system. After successfully booting the updated version of the operating system, the version of the operating system that was previously booted using the first boot partition and the first directory can be considered a previous version of the operating system. Accordingly, the updated version of the operating system associated with the second boot partition and the second directory can be a new current version of the operating system. If another update file is released, the computing device can apply a different software update to the first boot partition and the first directory based on the other update file while the updated version of the operating system remains operational.

Illustrative examples are given to introduce the reader to the general subject matter discussed herein and are not intended to limit the scope of the disclosed concepts. The following sections describe various additional features and examples with reference to the drawings in which like numerals indicate like elements, and directional descriptions are used to describe the illustrative aspects, but, like the illustrative aspects, should not be used to limit the present disclosure.

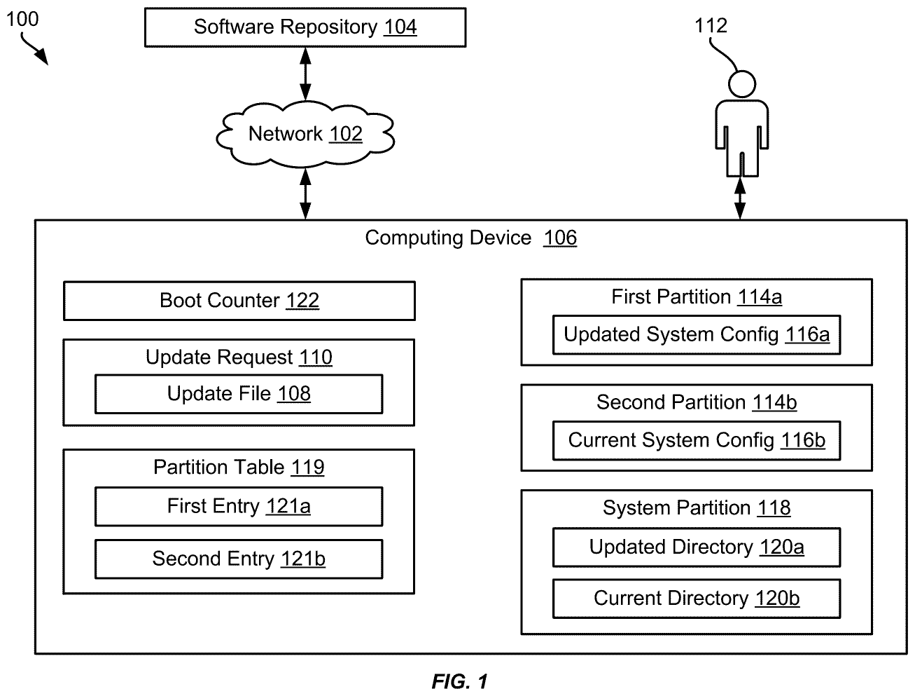

FIG. 1 is a block diagram of an example of a computing environment 100 for using hybrid partitioning to apply a software update according to some examples of the present disclosure. Components within the computing environment 100 may be communicatively coupled via a network 102, such as a local area network (LAN), wide area network (WAN), the Internet, or any combination thereof. For example, the computing environment 100 can include a software repository 104 and a computing device 106 that are communicatively coupled through the network 102. Examples of the computing device 106 can include a desktop computer, a laptop computer, a mobile phone, or a tablet. In some implementations, the computing device 106 can be an edge device or a resource-constrained device, such as a microcontroller, a smart device, or a sensor. For example, the computing device 106 may be part of an automotive system, such as a car. The computing device 106 can include software, such as system software, applications, database software, multimedia software, middleware, etc., that runs on the computing device 106 to execute specific tasks or provide certain functionality. For example, system software can include low-level software (e.g., an operating system) used to manage or control hardware of the computing device 106 and provide basic functions to higher-level software.

After the software is released to be installed, a software developer may generate one or more software updates to modify the software, such as to address vulnerabilities or add functionality of the software. The computing device 106 can communicate with the software repository 104, such as an update server, to obtain and install a software update. For instance, the software developer may store an update file 108 in the software repository 104 to enable end users to download a software update onto a respective computing device. In some cases, the software update may be provided as part of a software package that may include one or more software programs or one or more software program updates. The software programs or software program updates can be packaged together in a format that enables installation on the computing device 106. Additionally, the software package can include metadata that describes the software package, such as identifiers associates with a version and release of the software update in the software package.

In some examples, the computing device 106, such as an update manager of the computing device 106, can transmit an update request 110 to the software repository 104 to request the update file 108 from the software repository 104. For example, the computing device 106 may transmit the update request 110 in response to user input provided by an end user 112 associated with the computing device 106 to initiate the software update. For example, the end user 112 may use an input/output device communicatively coupled to the computing device 106 to provide the user input via a user interface. Once the computing device 106 receives the update file 108, the computing device 106 can initiate an update process using hybrid partitioning to generate an updated version of the software installed on the computing device 106. In particular, the hybrid partitioning can enable the computing device 106 to generate the updated version of the software while a current version of the software is running. In some implementation, the update process can involve an atomic update in that the update file 108 is either fully applied to generate the updated version of the software or not applied at all. In other words, the atomic update can prevent a partial update of the software. In some examples, the update manager or another suitable component of the computing device 106 may validate the update file 108 prior to initiating the update process. Validating the update file 108 can involve checking for discrepancies, incongruences, or vulnerabilities in the update file 108. Additionally, the computing device 106 may unpack the update file 108, such as by extracting one or more files from a compressed file (e.g., a ZIP file).

The computing device 106 can include a partitioning scheme with separate partitions (e.g., a first partition 114a and a second partition 114b) and a system partition that can include separate organizational structures, such as directories. In some examples, the partitions 114a-b can be referred to as volumes. The separate partitions and the separate directories can provide hybrid partitioning such that an active system configuration of the computing device 106 is separated from an inactive system configuration of the computing device 106. For example, an updated system configuration 116a can be generated by using the update file 108 to update the inactive system configuration of the first partition 114a. The active system configuration can be a current system configuration 116b corresponding to the second partition 114b that is executed prior to or while the first partition 114a is updated.

In general, a system configuration of the computing device 106 can correspond to a specification of the computing device 106, such as hardware components or software components that are run within the computing device 106. For example, the system configuration can indicate types or models of devices installed on the computing device 106 or specific software used to run various parts of the computing device. As another example, the system configuration can refer to operating system settings that have been automatically or manually by a given software program or by the end user 112. By distinguishing between the active and inactive system configurations, the hybrid partitioning can enable the computing device 106 to apply the software update to the inactive system configuration while the active system configuration is running. In some examples, the end user 112 may provide the user input to initiate the software update while the computing device 106 is running the current system configuration 116b. For example, the end user 112 can provide user input via a touchscreen of the computing device 106 to initiate a software update to an existing software version installed on the computing device 106.

In some examples, the partitions 114a-b can be created by allocating disk space of a storage compartment (e.g., a disk drive) of the computing device 106. Examples of the disk drive can include hard disk drives and solid-state drives. For example, the end user 112 can indicate a number of megabytes as a size of the first partition 114a to allocate a corresponding amount of disk space to the first partition 114a. In some implementations, the partitions 114a-b can be used for a boot sequence of the computing device 106 that is implemented when the computing device 106 is powered on or reset. In some cases, the computing device 106 may have at least two partitions 114. One partition can correspond to an active system configuration while another partition may correspond to an inactive system configuration that can be updated with minimal interference to system operations of the computing device 106. For example, if the software update corresponds to the operating system of the computing device 106, the computing device 106 can update the first partition 114a of the computing device 106 that is inactive while the second partition 114b is active. Specifically, an inactive version or configuration of the operating system associated with the first partition 114a can be updated while an active version of the operating system runs using the second partition 114b of the computing device 106. While the first partition 114a is inactive, other components of the computing device 106 may be unable to access the first partition 114a, thereby preventing unauthorized modifications to the first partition 114a while the first partition 114a is being updated.

In addition to the partitions 114a-b, the hybrid partitioning of the computing device 106 can include a system partition 118 that can include one or more directories 120 to separate the active system configuration from the inactive system configuration. In some cases, the system partition 118 can be a root filesystem (rootfs) partition, which can include files or subdirectories critical to system operation. For example, the rootfs partition can include a filesystem that contains a device directory and programs to boot the computing device 106. Additionally, the filesystem of the rootfs partition can include mount points where other filesystems can be mounted to connect to the rootfs. In some examples, the system partition 118 can be the largest partition of a disk drive of the computing device 106 such that the system partition 118 is allocated the most storage of the disk drive. By implementing the hybrid partitioning, the computing device 106 can avoid duplicating data in the system partition 118 and thereby conserve storage in the disk drive for other data.

The directories (e.g., an updated directory 120a and a current directory 120b) can distinguish between the inactive system configuration and the active system configuration. In some examples, the updated directory 120a can include the update file 108 or a portion of the update file 108 such that the updated directory 120a can be used to execute the updated version of the software. For example, due to the system partition 118 having a filesystem, the current directory 120b can share data with the updated directory 120a to reduce storage usage. By sharing data with the current directory 120b, the updated directory 120a can store a portion of the update file 108 that is different from current code or current data stored in the current directory 120b. In other words, the updated directory 120a can access data of the current directory 120b, thereby avoiding storing a copy of data provided by the update file 108 that is already available in the current directory 120b.

While the computing device 106 generates or updates the updated directory 120a based on the update file 108, the current directory 120b can remain operational to prevent interruptions or downtime with respect to using the computing device 106. For example, until the computing device 106 completes the update process of applying the update file 108 to the first partition 114a and the updated directory 120a, the computing device 106 can boot using the second partition 114b and the current directory 120b. If the computing device 106 is rebooted before the first partition 114a is updated or before the updated directory 120a is generated, the computing device 106 can use the second partition 114b and the current directory 120b to boot. In some cases, the update process can be referred to as a staged update process. While the software update is being applied, the update process may be hidden from the end user 112 of the computing device 106 and system operations of the computing device 106 may remain unaffected by the software update. For example, the computing device 106 can continue to perform its typical functions while any changes provided by the update file 108 can be applied to the first partition 114a or used to generate the updated directory 120a. In some examples, the updated directory 120a may be an existing directory of the system partition 118 that is updated based on the update file 108.

Once the software update has been applied, the computing device 106 can execute a reboot, such as based on a reboot command. In some cases, the reboot command may be initiated by the end user 112. For example, the end user 112 can interact with a user interface outputted by the computing device 106 to provide user input to initiate a restart process of the computing device 106. In other cases, the computing device 106 may receive the reboot command from another component in the computing environment 100. For example, if the computing device 106 is an edge device, the computing device 106 can be communicatively coupled to a central controller that can transmit the reboot command to the edge device. In these scenarios, the central controller may oversee one or more edge devices in a distributed computing environment. For example, the central controller may provide suitable administrative management related to the edge devices, such as authorizing updates for the edge devices. As another example, the central controller may track existing software versions of the edge devices to determine whether a software update is available.

In some implementations, determining a timing of when to execute the reboot command can involve usage of the computing device 106. For example, the computing device 106 may reboot during a time window within which the end user 112 does not use the computing device 106, such as between 1 AM and 5 AM local time, to ensure uninterrupted device functionality. As another example, in automotive applications, the computing device 106 may reboot once the end user 112 has returned home from work or based on other suitable patterns in the usage of a vehicle associated with the computing device 106. In some examples, the computing device 106 may need to be updated by a certain time or within a certain time frame regardless of whether the computing device 106 is in use. For example, the software update may be an urgent update to address a vulnerability that can be exploited by malicious actors. Based on a predetermined amount of time having been exceeded, the reboot command may be executed or transmitted to the computing device 106. For example, the computing device 106 may automatically reboot eight hours after receiving the reboot command from the central controller. As another example, the central controller may transmit the reboot command to the computing device 106 at midnight such that the computing device 106 reboots in response to receiving the reboot command.

In some implementations, the computing device 106 can be adjusted to reboot using the first partition 114a that has been updated to implement the updated system configuration 116a. For example, once the first partition 114a has been updated, a partition table 119 of the computing device 106 can be modified such that the computing device 106 will boot using the first partition 114a upon a subsequent reboot. In some examples, the partition table 119 can include a first entry 121a corresponding to the first partition 114a and a second entry 121b corresponding to the second partition 114b. Each entry 121 of the partition table 119 can include a respective indicator (e.g., a value) that indicates which partition of the partitions 114a-b to use during the reboot. Accordingly, once the first partition 114a has been updated, the first entry 121a can be modified to include a particular indicator such that the computing device 106 is configured to boot using the first partition 114a instead of the second partition 114b.

Once the partition table 119 has been modified, the second partition 114b then can become the inactive partition that later can be updated by the computing device 106 based on a new software update. In other words, the partitions 114a-b can switch between an active status and an inactive status based on which partition was last updated. The active status or the inactive status can depend on whether a respective boot flag is set in the entries 121a-b of the partition table 119. For example, a value of 0x80 as a boot flag of a particular entry in the partition table 119 can indicate that a corresponding partition of the particular entry is an active partition to be used for booting. The active partition can correspond to the active system configuration of the computing device 106.

Additionally, the computing device 106 can continue performing the reboot by using the updated directory 120a of the system partition 118. Successfully booting using the first partition 114a and the updated directory 120a can complete the update process such that the computing device 106 executes the updated version of the software (e.g., the operating system). In some cases, the update process may be incomplete or unsuccessful. For example, the updated version of the software can become corrupted due to errors in applying the update file 108 such that the updated version of the software is inoperative or non-functional. As another example, the update process can be unsuccessful if the computing device 106 is unable to boot using the first partition 114a and the updated directory 120a, such as due to a computing incompatibility.

In some implementations, the computing device 106 can include one or more rollback features, one or more recovery features, or a combination thereof. These features can enable unattended updates in which the computing device 106 can automatically detect incomplete or unsuccessful updates and automatically roll back to a functional system configuration. For example, the computing device 106 can revert to a previous system configuration in case of any update failures or compatibility issues related to the updated version of the software or the update file 108. More specifically, if the update process is unsuccessful, the computing device 106 may revert from the updated system configuration 116a to system configuration 116b or another suitable previous system configuration. For instance, after a predefined number of attempts at booting using the first partition 114a, the computing device 106 may forgo additional attempts to boot the updated system configuration 116a of the first partition 114a. By implementing separate partitions in the hybrid partitioning, system configuration 116b that was previously functional remains available if the update process is unsuccessful.

In some examples, the number of attempts at booting can be referred to as a boot count. The computing device 106 can include a boot counter 122 that can track the boot count, such as by decrementing a preset value after each attempted boot of the computing device 106. For example, the boot counter 122 can decrease the preset value by one each time the computing device 106 reboots. The preset value can indicate a tolerance of the attempted boots. If the preset value reaches the predefined threshold, the computing device 106 can apply a rollback process to boot using a previous system configuration that is known to be functional or operational. Once the computing device 106 is successfully booted, the boot counter 122 can be reset, such as by reverting the preset value to its original value. For example, resetting the boot counter 122 can involve reverting the preset value to seven each time the computing device 106 is successfully booted.

The computing device 106 can maintain a record of one or more previous updates or one or more previous system configurations. Accordingly, the updated version of the software can be reverted to a different system configuration that was previously operational. For instance, the rollback process can involve booting the computing device 106 using system configuration 116b corresponding to the second partition 114b. As a specific example, if the preset value is seven, the computing device 106 can unsuccessfully reboot the updated system configuration 116a seven times before the computing device 106 reverts to system configuration 116b. In some cases, if the preset value reaches zero, the system configuration 116 being booted can be marked as inoperative or otherwise failing to boot. For example, the boot counter 122 may output an alert to indicate that booting the updated system configuration 116a using the first partition 114a has failed. Based on the alert, the computing device 106 can implement one or more remedial actions, such as rolling back to a previously functional system configuration or performing a health check.

While FIG. 1 depicts a specific arrangement of components, other examples can include more components, fewer components, different components, or a different arrangement of the components shown in FIG. 1. For instance, in other examples, the computing device 106 may receive update files from multiple software repositories. For example, the computing device 106 can be communicatively coupled with the software repository 104 to receive updates for its operating system and with another software repository to receive updates for a word processor application. Additionally, any component or combination of components depicted in FIG. 1 can be used to implement the process(es) described herein.

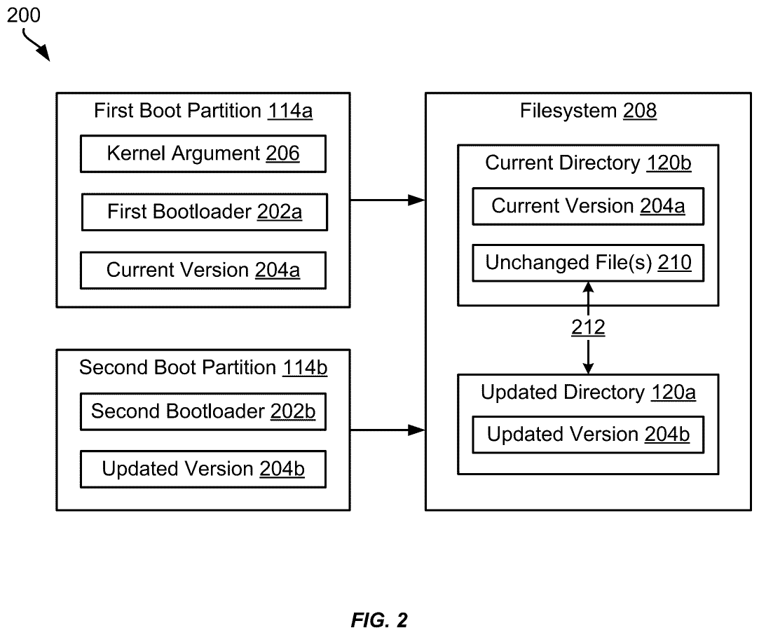

FIG. 2 is a block diagram of an example of a portion 200 of a computing device (e.g., the computing device 106 of FIG. 1) to apply a software update using hybrid partitioning according to some examples of the present disclosure. Certain aspects of FIG. 2 are described below with respect to components of FIG. 1. Components of the computing device shown in FIG. 2 can be used to perform a booting sequence of the computing device. For example, the portion 200 of the computing device includes a first bootloader 202a and a second bootloader 202b. In some cases, the bootloaders 202a-b can also be referred to as a bootstrap loader.

When the computing device is turned off (e.g., powered off or shut down), its software may remain stored on non-volatile memory. Upon the computing device being powered on, firmware of the computing device can check for the bootloaders 202a-b, such as using a boot signature or a boot record that can indicate or identify the bootloaders 202a-b. Examples of the firmware can include Basic Input/Output System (BIOS) or Unified Extensible Firmware Interface (UEFI). In some cases, the firmware can use a partition table (e.g., the partition table 119 of FIG. 1) to locate the bootloaders 202a-b and determine which of the bootloaders 202a-b to select to load. The selected bootloader then may execute one or more programs or data to load data of an operating system of the computing device into working memory (e.g., random-access memory (RAM)) of the computing device. For example, the first bootloader 202a or the second bootloader 202b can load a kernel of the computing device and launch an operating system of the computing device.

In some examples, as described above with respect to FIG. 1, the computing device can include separate partitions (e.g., a first boot partition 114a and a second boot partition 114b) as part of the hybrid partitioning to apply the software update. The first boot partition 114a can correspond to the first bootloader 202a, such as by containing the first bootloader 202a. Similarly, the second boot partition 114b can correspond to the second bootloader 202b. The boot partitions 114a-b can include a respective version of software. For example, the first boot partition 114a can include a current version 204a of the software, while the second boot partition 114b can include a previous version of the software that is updated to become an updated version 204b of the software.

In some cases, a respective set of boot files (e.g., the kernel) can be mounted at each boot partition. Applying the software update can involve modifying a particular set of boot files corresponding to an inactive boot partition of the computing device. Additionally, each boot partition 114 can include a respective kernel argument that can indicate a current boot partition that was used to boot the computing device. For example, when applying the software update, the computing device can determine that the first boot partition 114a is an active boot partition that has been used to boot the computing device based on a kernel argument 206 of the first boot partition 114a. Based on the first boot partition 114a being the active boot partition, the computing device can apply the software update to the inactive boot partition (e.g., the second boot partition 114b). Accordingly, device functionality of the computing device can remain unaffected while the software update is applied to the second boot partition 114b.

In addition to the partitions 114a-b, the computing device can include a filesystem 208 corresponding to a system partition (e.g., the system partition 118 of FIG. 1) of the computing device. The filesystem 208 can include one or more organizational structures, such as an updated directory 120a and a current directory 120b different from the updated directory 120a. The directories 120a-b can separate a current system configuration from an updated system configuration. For example, the updated directory 120a can correspond to the updated version 204b of the software, while the current directory 120b can correspond to the current version 204a of the software. In some cases, the directories 120a-b may separate the current system configuration from a previous system configuration, such as prior to applying the software update. In other cases, the filesystem 208 may lack the updated directory 120a until the software update is applied to generate the updated directory 120a. Once the software update is applied to the previous system configuration, the updated system configuration can be generated.

In some examples, the computing device can apply the software update by comparing the current version 204a of the software with the updated version 204b of the software, for example, as provided in an update package. The computing device can determine one or more unchanged files 210 that the current version 204a and the updated version 204b of the software have in common. To conserve storage, the computing device can generate the updated directory 120a to include data of the updated version 204b that is different from the current version 204a of the software. In some implementations, the computing device can generate one or more mappings 212 between the updated directory 120a and the current directory 120b such that the updated directory 120a can access the unchanged files 210. The mappings 212 can provide a shallow copy of the unchanged files 210, thereby conserving computational resources. Once the updated directory 120a is generated, the computing device can link the updated boot partition (e.g., the second boot partition) to the updated directory 120a in the filesystem 208. For example, the computing device can generate a file (e.g., a symbolic link or a symlink) that can indicate a corresponding directory in the filesystem 208 for each boot partition 114.

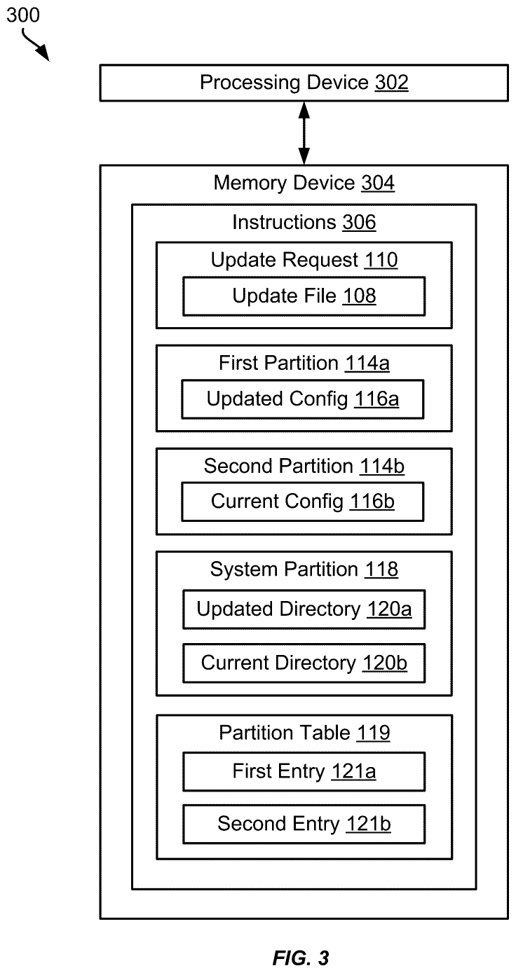

FIG. 3 is a block diagram of an example of a computing device 300 for using hybrid partitioning to apply a software update according to some examples of the present disclosure. The computing device 300 can include a processing device 302 communicatively coupled to a memory device 304. In some examples, the computing device 300 can be the computing device 106 of FIG. 1.

The processing device 302 can include one processing device or multiple processing devices. The processing device 302 can be referred to as a processor. Non-limiting examples of the processing device 302 include a Field-Programmable Gate Array (FPGA), an application-specific integrated circuit (ASIC), and a microprocessor. The processing device 302 can execute instructions 306 stored in the memory device 304 to perform operations. In some examples, the instructions 306 can include processor-specific instructions generated by a compiler or an interpreter from code written in any suitable computer-programming language, such as C, C++, C#, Java, Python, or any combination of these.

The memory device 304 can include one memory device or multiple memory devices. The memory device 304 can be non-volatile and may include any type of memory device that retains stored information when powered off. Non-limiting examples of the memory device 304 include electrically erasable and programmable read-only memory (EEPROM), flash memory, or any other type of non-volatile memory. At least some of the memory device 304 includes a non-transitory computer-readable medium from which the processing device 302 can read instructions 306. A computer-readable medium can include electronic, optical, magnetic, or other storage devices capable of providing the processing device 302 with the instructions 306 or other program code. Non-limiting examples of a computer-readable medium include magnetic disk(s), memory chip(s), ROM, random-access memory (RAM), an ASIC, a configured processor, and optical storage.

In some examples, the processing device 302 can communicate with an update repository (e.g., the software repository 104 of FIG. 1) to obtain an update file 108 to begin an update process of applying the software update. Applying the software update can modify a previous system configuration of the computing device 300 to generate an updated system configuration 116a. By implementing hybrid partitioning, the previous system configuration or the updated system configuration 116a can be inactive while a current system configuration 116b is used to run the computing device 300. In some cases, the processing device 302 can transmit an update request 110 to the update repository to determine whether the software update is available and to request the update file 108 if available. In other cases, the update request 110 instead may be generated by the processing device 302 in response to user input requesting the software update. In any case, the processing device 302 can generate the update request 110 while running the current system configuration 116b as an active system configuration of the computing device 300.

Once the processing device 302 receives the update file 108, the processing device 302 can use the update file 108 to generate an updated version of software installed on the memory device 304. For example, the processing device 302 can generate the updated system configuration 116a based on the update file 108 such that the updated system configuration 116a provides additional features that are unavailable in the current system configuration 116b. Using the hybrid partitioning to apply the software update can include updating a first partition 114a that is inactive while a second partition 114b remains active and operational. For example, the first partition 114a can correspond to an inactive system configuration. The processing device 302 can modify one or more boot files of the first partition 114a based on the update file 108 to apply the software update and generate the updated system configuration.

Once the first partition 114a has been updated, the processing device 302 can modify a partition table 119 of the computing device 300 such that the computing device 300 reboots to implement the updated system configuration 116a of the first partition 114a. More specifically, the processing device 302 can modify a first entry 121a of the partition table 119 corresponding to the first partition 114a to indicate that the first partition 114a is an active partition. Additionally, the processing device 302 can modify a second entry 121b of the partition table 119 associated with the second partition 114b such that the second partition 114b becomes an inactive partition.

Using the hybrid partitioning to apply the software update additionally can include generating an updated directory 120a in a system partition 118 of the computing device 300. Unlike the partitions 114a-b, the system partition 118 can include a filesystem that can include one or more directories to organize data in the system partition 118. To prevent data duplication, the processing device 302 can determine whether certain portions of the current system configuration 116b are the same as the updated system configuration 116a. The processing device 302 then can generate the updated directory 120a to selectively include a subset of the update file 108 that is different from the current system configuration 116b.

Once the processing device 302 updates the first partition 114a and the updated directory 120a, the processing device 302 can initiate a reboot of the computing device 300. The processing device 302 can use the first partition 114a and the updated directory to reboot the computing device 300 such that the updated system configuration 116a switches with the current system configuration 116b. After switching, the current system configuration 116b can be considered a previous system configuration or an inactive system configuration and can be updated at a later time. Accordingly, the updated system configuration 116a can be considered a new current system configuration of the computing device 300. The update process can finish once the updated system configuration 116a is successfully booted by the processing device 302.

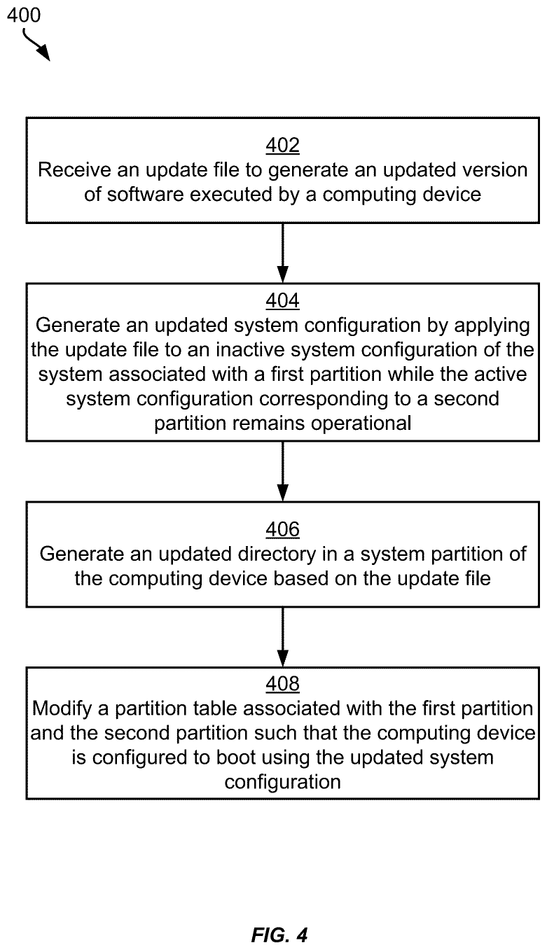

FIG. 4 is a flowchart of a process 400 for using hybrid partitioning to apply a software update according to some examples of the present disclosure. In some examples, the processing device 302 can perform one or more of the steps shown in FIG. 4. In other examples, the processing device 302 can implement more steps, fewer steps, different steps, or a different order of the steps depicted in FIG. 4. The steps of FIG. 4 are described below with reference to components discussed above in FIGS. 1-3.

In block 402, the processing device 302 receives an update file 108 to generate an updated version of software executed in a computing device 106. In some implementations, the computing device 106 may be part of an automotive system. The update file 108 can correspond to an update request 110 generated while running an active system configuration of the computing device 106. After determining that a software update for the computing device 106 has been released, the processing device 302 can transmit the update request 110 to a software repository 104 to obtain the update file 108. For example, the processing device 302 can determine that a current version of the software (e.g., an operating system) is outdated based on a new version being available in the software repository 104. In some cases, in response to the update request 110, the processing device 302 may receive more than one update file or an update package including one or more update files from the software repository 104.

In block 404, subsequent to receiving the update file 108, the processing device 302 generates an updated system configuration 116a by applying the update file 108 to an inactive system configuration of the computing device 106 associated with a first partition 114a. The processing device 302 can apply the update file 108 to the inactive system configuration while the active system configuration remains operational, such as using a second partition 114b. In some examples, the update file 108 may be packaged in a signed binary blob that includes updates to a kernel, a filesystem 208 (e.g., initramfs), a command line, a device tree blob (DTB), or a combination thereof. The processing device 302 can write the signed binary blob to the first partition 114a to update the first partition 114a.

In block 406, the processing device 302 generates an updated directory 120a in a system partition 118 of the computing device 106 based on the update file 108. The updated directory 120a can correspond to the updated system configuration of the first partition 114a. The processing device 302 can compare the current version of the software with the update file 108 to determine whether a set of unchanged files 210 are available in a current directory 120b associated with the current system configuration 116b. For example, if the update file 108 includes a patch to address a vulnerability of the operating system, the processing device 302 can isolate a particular portion or a subset of code in the update file 108 to update or generate the updated directory 120a. The remaining portion of the update file 108 that is unchanged between the current version of the software and the update file 108 can be shared between the updated directory 120a and the current directory 120b. For example, the processing device 302 can generate one or more mappings 212 that the updated directory 120a can use to access the unchanged files 210.

Once the updated directory 120a is populated or updated, the processing device 302 can use a kernel argument of the second partition 114b to determine that the second partition 114b is currently active or was used to boot the computing device 106. The processing device 302 then can set a symlink to map the updated directory 120a to the first partition 114a. On the next reboot of the computing device 106, the computing device 106 can boot using the first partition 114a and the updated directory 120a to run the updated version of the software. In some examples, the computing device 106 may boot using the first partition 114a based on a partition table 119 of the computing device 106. For example, after applying the software update and prior to rebooting, the processing device 302 can switch the partition table 119 from booting using the second partition 114b to using the first partition 114a. More specifically, the processing device 302 can modify a first entry 121a and a second entry 121b of the partition table 119 such that first partition 114a is the active partition instead of the second partition 114b.

The foregoing description of certain examples, including illustrated examples, has been presented only for the purpose of illustration and description and is not intended to be exhaustive or to limit the disclosure to the precise forms disclosed. Numerous modifications, adaptations, and uses thereof will be apparent to those skilled in the art without departing from the scope of the disclosure.

What is claimed is:

1. A system comprising:
a processing device; and
a memory device including instructions that are executable by the processing device for causing the processing device to perform operations comprising:
receiving an update file to generate an updated version of software executed by the system, the update file corresponding to an update request generated while running an active system configuration of the system;
generating an updated system configuration by applying the update file to an inactive system configuration of the system associated with a first partition while the active system configuration corresponding to a second partition remains operational;
generating an updated directory in a system partition of the system based on the update file, the updated directory corresponding to the updated system configuration of the first partition; and
modifying a partition table associated with the first partition and the second partition such that the system is configured to boot using the updated system configuration of the first partition and the updated directory upon rebooting.

2. The system of claim 1, wherein the operations further comprise, subsequent to modifying the partition table:
executing a reboot of the system to switch from the active system configuration to the updated system configuration, wherein the system previously booted using the second partition prior to receiving the update file.

3. The system of claim 2, wherein executing the reboot of the system further comprises:
determining, based on a kernel argument of the first partition, that the first partition corresponds to the updated directory; and
in response to determining that the first partition corresponds to the updated directory, completing the reboot of the system using the updated directory.

4. The system of claim 1, wherein the system partition comprises a filesystem including the updated directory and a current directory different from the updated directory, and wherein the current directory is used to execute the active system configuration associated with the second partition.

5. The system of claim 4, wherein generating the updated directory further comprises:
determining a set of unchanged files between the update file and a current version of the software associated with the current directory; and
based on the set of unchanged files, generating the updated directory by including one or more mappings to share the set of unchanged files between the updated directory and the current directory.

6. The system of claim 1, wherein the operations further comprise:
determining that the updated version of the software is inoperative; and
in response to determining that the updated version of the software is inoperative, applying a rollback process to boot the system using the second partition that was previously operational.

7. The system of claim 6, wherein determining that the updated version of the software is inoperative further comprises:
determining, based on a boot counter, that a boot count of the system has exceeded a predefined threshold, wherein the boot counter is configured to update the boot count in response to a boot of the system being attempted.

8. A method comprising:
receiving an update file to generate an updated version of software executed by a computing device, the update file corresponding to an update request generated while running an active system configuration of the computing device;
generating an updated system configuration by applying the update file to an inactive system configuration of the computing device associated with a first partition while the active system configuration of the computing device corresponding to a second partition remains operational;
generating an updated directory in a system partition of the computing device based on the update file, the updated directory corresponding to the updated system configuration of the first partition; and
modifying a partition table associated with the first partition and the second partition such that the computing device is configured to boot using the updated system configuration of the first partition and the updated directory upon rebooting.

9. The method of claim 8, further comprising, subsequent to modifying the partition table:
executing a reboot of the computing device to switch from the active system configuration to the updated system configuration, wherein the computing device previously booted using the second partition prior to receiving the update file.

10. The method of claim 9, wherein executing the reboot of the computing device further comprises:
determining, based on a kernel argument of the first partition, that the first partition corresponds to the updated directory; and
in response to determining that the first partition corresponds to the updated directory, completing the reboot of the computing device using the updated directory.

11. The method of claim 8, wherein the system partition comprises a filesystem including the updated directory and a current directory different from the updated directory, and wherein the current directory is used to execute the active system configuration associated with the second partition.

12. The method of claim 11, wherein generating the updated directory further comprises:
determining a set of unchanged files between the update file and a current version of the software associated with the current directory; and
based on the set of unchanged files, generating the updated directory by including one or more mappings to share the set of unchanged files between the updated directory and the current directory.

13. The method of claim 8, further comprising:
determining that the updated version of the software is inoperative; and
in response to determining that the updated version of the software is inoperative, applying a rollback process to boot the computing device using the second partition that was previously operational.

14. The method of claim 13, wherein determining that the updated version of the software is inoperative further comprises:
determining, based on a boot counter, that a boot count of the computing device has exceeded a predefined threshold, wherein the boot counter is configured to update the boot count in response to a boot of the computing device being attempted.

15. A non-transitory computer-readable medium comprising program code executable by a processing device of a computing device for causing the processing device to perform operations comprising:
receiving an update file to generate an updated version of software executed by the computing device, the update file corresponding to an update request generated while running an active system configuration of the computing device;
generating an updated system configuration by applying the update file to an inactive system configuration of the computing device associated with a first partition while the active system configuration of the computing device corresponding to a second partition remains operational;
generating an updated directory in a system partition of the computing device based on the update file, the updated directory corresponding to the updated system configuration of the first partition; and
modifying a partition table associated with the first partition and the second partition such that the computing device is configured to boot using the updated system configuration of the first partition and the updated directory upon rebooting.

16. The non-transitory computer-readable medium of claim 15, wherein the operations further comprise, subsequent to modifying the partition table:
executing a reboot of the computing device to switch from the active system configuration to the updated system configuration, wherein the computing device previously booted using the second partition prior to receiving the update file.

17. The non-transitory computer-readable medium of claim 16, wherein executing the reboot of the computing device further comprises:
determining, based on a kernel argument of the first partition, that the first partition corresponds to the updated directory; and
in response to determining that the first partition corresponds to the updated directory, completing the reboot of the computing device using the updated directory.

18. The non-transitory computer-readable medium of claim 15, wherein the system partition comprises a filesystem including the updated directory and a current directory different from the updated directory, and wherein the current directory is used to execute the active system configuration associated with the second partition.

19. The non-transitory computer-readable medium of claim 18, wherein generating the updated directory further comprises:
determining a set of unchanged files between the update file and a current version of the software associated with the current directory; and
based on the set of unchanged files, generating the updated directory by including one or more mappings to share the set of unchanged files between the updated directory and the current directory.

20. The non-transitory computer-readable medium of claim 15, wherein the operations further comprise:
determining that the updated version of the software is inoperative; and
in response to determining that the updated version of the software is inoperative, applying a rollback process to boot the computing device using the second partition that was previously operational.
